(19) United States
(12) Patent Application Publication
(10) Pub. No.: US 2014/0326528 A1
(43) Pub. Date: Nov. 6, 2014

(54) EXHAUST PIPE WATER DAM FOR A WORK VEHICLE

(71) Applicant: CNH Industrial America LLC, New Holland, PA (US)

(72) Inventor: Richard A. Moen, Glenwood, MN (US)

(73) Assignee: CNH INDUSTRIAL AMERICA LLC, New Holland, PA (US)

(21) Appl. No.: 14/263,244

(22) Filed: Apr. 28, 2014

Related U.S. Application Data
(60) Provisional application No. 61/818,367, filed on May 1, 2013.

(51) Int. Cl. B60K 13/04

(52) U.S. Cl. CPC B60K 13/04
USPC 180/309

(57) ABSTRACT

A vehicle includes a chassis and an internal combustion (IC) engine carried by the chassis. The IC engine includes an exhaust system with a protected component and an exhaust pipe fluidly connected with the protected component. The exhaust pipe includes an inside diameter with a lower surface and a water dam connected with a predefined portion of the lower surface, whereby water is inhibited from flowing through the exhaust pipe and into the protected component.

This is a non-provisional application based upon U.S. provisional patent application Ser. No. 61/818,367, entitled “EXHAUST PIPE WATER DAM”, filed May 1, 2013, which is incorporated herein by reference.

### BACKGROUND OF THE INVENTION

1. Field of the Invention

The present invention relates to exhaust systems for work vehicles, and, more particularly, to exhaust systems which include a catalytic converter for exhaust emissions control.

2. Description of the Related Art

Work vehicles may include any type of off-road vehicle which is primarily used for utilitarian work functions, such as agricultural, construction, industrial or forestry work machines. Agricultural work vehicles in the form of agricultural sprayers apply a liquid to a crop or the ground at a specified application rate. The liquid may be in the form of a solution or mixture, with a carrier liquid (such as water) being mixed with one or more active ingredients (such as a herbicide, fertilizer and/or a pesticide). The application rate can vary over different parts of a field through the use of precision farming techniques, such as by using GPS data to activate/deactivate boom sections of the sprayer as the sprayer traverses over the field.

Agricultural sprayers may be pulled as an implement or self-propelled, and typically include a tank, a pump, a boom assembly, and a plurality of nozzles carried by the boom assembly at spaced locations. The boom assembly typically includes a pair of wing booms, with each wing boom extending to either side of the sprayer when in an unfolded state. Each wing boom may include multiple boom sections, each with a number of spray nozzles (also sometimes referred to as spray tips). Of course, a self-propelled sprayer also includes an onboard power plant (e.g., diesel engine) providing motive force and other power such as hydraulic power, electrical power, etc.

The emissions from diesel engines have been progressively regulated in the last decade or so such that emissions (primarily particulate matter and nitrous oxides (NoX)) must be less and less. One common approach to reduce emissions uses exhaust gas recirculation (EGR) while another common approach uses selective catalytic reduction (SCR). It is also possible to use a combination of each of these emissions control methodologies. When using an exhaust system with SCR, care must be taken to avoid water entering the SCR because the water can negatively affect the chemical reaction within the SCR. The use of a muffler flapper at the end of the muffler or exhaust pipe can inhibit water from entering the exhaust pipe when the work vehicle is not running

What is needed in the art is an exhaust system for a work vehicle which eliminates water from the SCR.

### SUMMARY OF THE INVENTION

The present invention provides an exhaust system for an internal combustion (IC) engine with an exhaust pipe having a water dam welded to the lower surface of the pipe to prevent water from running through the exhaust system.

The invention in one form is directed to a vehicle including a chassis and an IC engine carried by the chassis. The IC engine includes an exhaust system with a protected component (such as an SCR tank) and an exhaust pipe fluidly connected with the protected component. The exhaust pipe includes an inside diameter with a lower surface and a water dam connected with a predefined portion of the lower surface, whereby water is inhibited from flowing through the exhaust pipe and into the protected component.

The invention in another form is directed to an exhaust system for an IC engine in a vehicle. The exhaust system includes a protected component and an exhaust pipe fluidly connected with the protected component. The exhaust pipe includes an inside diameter with a lower surface and a water dam connected with a predefined portion of the lower surface, whereby water is inhibited from flowing through the exhaust pipe and into the protected component.

An advantage of the present invention is that the water dam inhibits water from running through the exhaust pipe to a protected component on the upstream side of the water dam.

Yet another advantage is that a hole is provided on the downstream side of the water dam to allow water to drain.

A further advantage is that the water dam is sized and positioned to inhibit water from spilling over the water dam, while not impeding the flow of exhaust through the exhaust pipe.

A still further advantage is that the water dam improves backpressure issues within the exhaust system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a work vehicle in the form of an agricultural sprayer which can include an IC engine with an embodiment of an exhaust system of the present invention;

FIG. 2 is a side view of the agricultural sprayer shown in FIG. 1, with the IC engine and exhaust system shown in phantom lines within the engine compartment;

FIG. 3 is a perspective view of a portion of the IC engine shown in FIG. 2, including an embodiment of an exhaust system of the present invention;

FIG. 4 is a perspective view of a portion of the exhaust system shown in FIGS. 2 and 3, showing an embodiment of a water dam of the present invention in the exhaust pipe;

FIG. 5 is a side view of the water dam shown in FIGS. 3 and 4; and

FIG. 6 is a sectional view of a portion of the exhaust pipe and water dam shown in FIGS. 3 and 4, taken along line 6-6 in FIG. 4.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

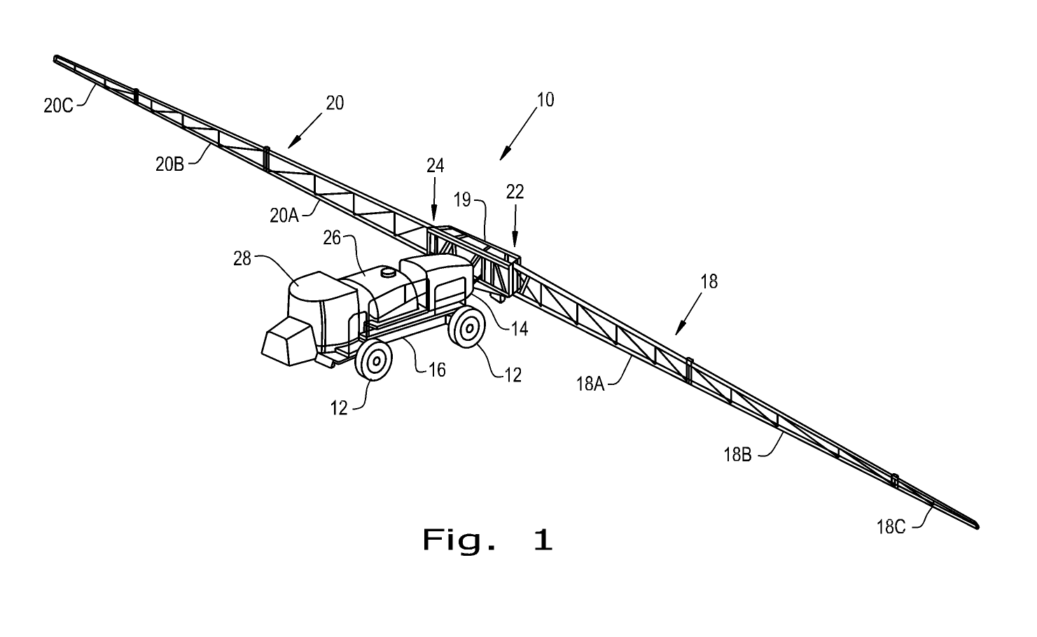

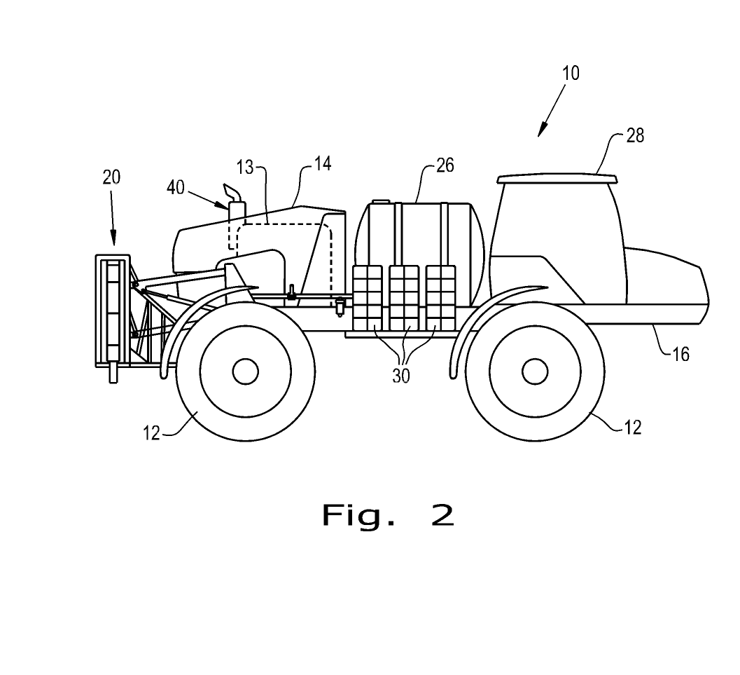

Referring now to the drawings, and more particularly to FIGS. 1 and 2, there is shown an agricultural vehicle in the form of an agricultural sprayer 10 which can include an internal combustion (IC) engine with an exhaust system of the present invention. Although the work vehicle is shown as a sprayer, it is to be understood that the work vehicle can be any other type of work vehicle, such as a tractor, combine, windrower, backhoe, excavator, feller-buncher, or any other type of work vehicle which includes an IC engine.

Agricultural sprayer 10 is shown as a self-propelled sprayer with a plurality of wheels 12 and a prime mover in the form of an IC engine, specifically a diesel engine 13, within an engine compartment 14. However, the IC engine could be a different type of IC engine, such as a gasoline or liquid propane (LP) engine. Moreover, agricultural sprayer 10 could also be a track-type self-propelled vehicle for certain applications.

Agricultural sprayer 10 also includes a chassis 16 to which a pair of wing booms 18, 20 are connected, united by a center boom 19. For sake of description, wing boom 18 is considered a left wing boom and wing boom 20 is considered a right wing boom. The wing booms 18, 20 are connected to center boom 19, joined about respective pivot connections 22, 24. Center boom 19 is connected at or near the rear of chassis 16. The wing booms 18, 20 are designed to fold forward toward the leading end of chassis 16 when wing booms 18, 20 are moved from an extended position, shown in FIG. 1, to a stowed or transport position (not shown).

Each wing boom 18, 20 supports a number of boom sections 18A, 18B, 18C, 20A, 20B and 20C. Center boom 19 and wing boom sections 18A, 18B, 18C, 20A, 20B and 20C each include a number of spray nozzles (not shown). In the embodiment shown, each wing boom has three boom sections, corresponding to the fold locations of the wing boom. In the illustrated embodiment, the spray nozzles of center boom 19 and wing boom sections 18A, 18B, 18C, 20A, 20B and 20C are fluidly connected in parallel relative to each other. Moreover, the spray nozzles within center boom 19 and a same wing boom section 18A, 18B, 18C, 20A, 20B or 20C are typically connected together in series. This arrangement of spray nozzles allows the spray nozzles of center boom 19 and wing boom sections 18A, 18B, 18C, 20A, 20B and 20C to be independently turned on and off as sprayer 10 advances across a field (e.g., using GPS data).

A carrier tank 26 is positioned generally in the center of chassis 16 between wing booms 18, 20 and behind an operator cab 28. Carrier tank 26 is designed to contain a carrier fluid, typically water, which is fed to the spray nozzles through a series of fluid lines (not shown). The water is mixed in a metered fashion with one or more active ingredients (i.e., agricultural chemicals such as fertilizer, herbicide or pesticide) stored in respective active ingredient tanks 30 also carried onboard sprayer 10. Metering devices for metering an active ingredient into a carrier liquid from carrier tank 26 are known in the art and not described in greater detail herein. Operator cab 28 contains a control panel (not shown) that has various operator controls for controlling operation of the sprayer and its components.

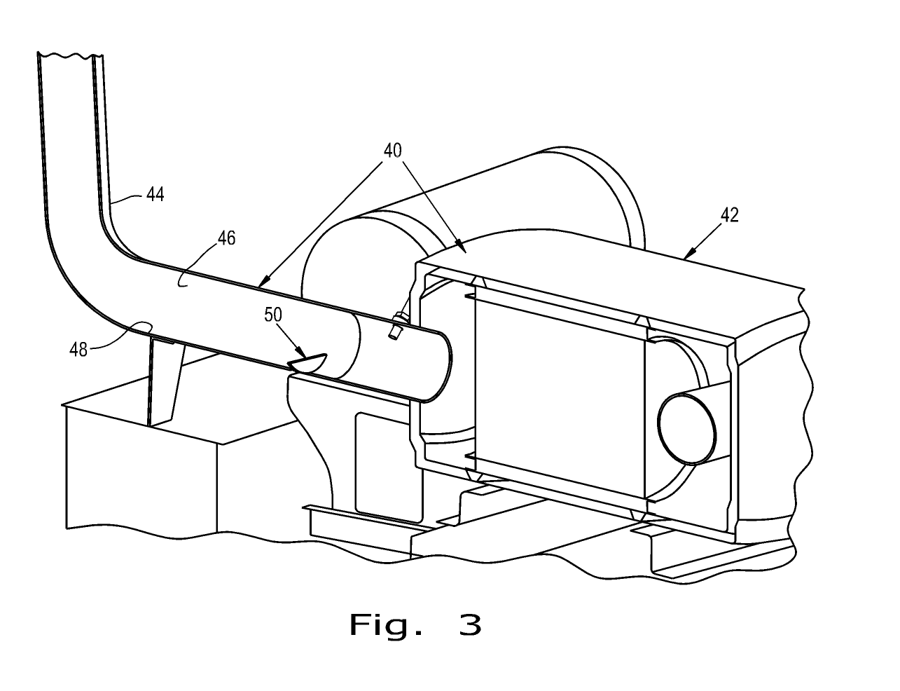

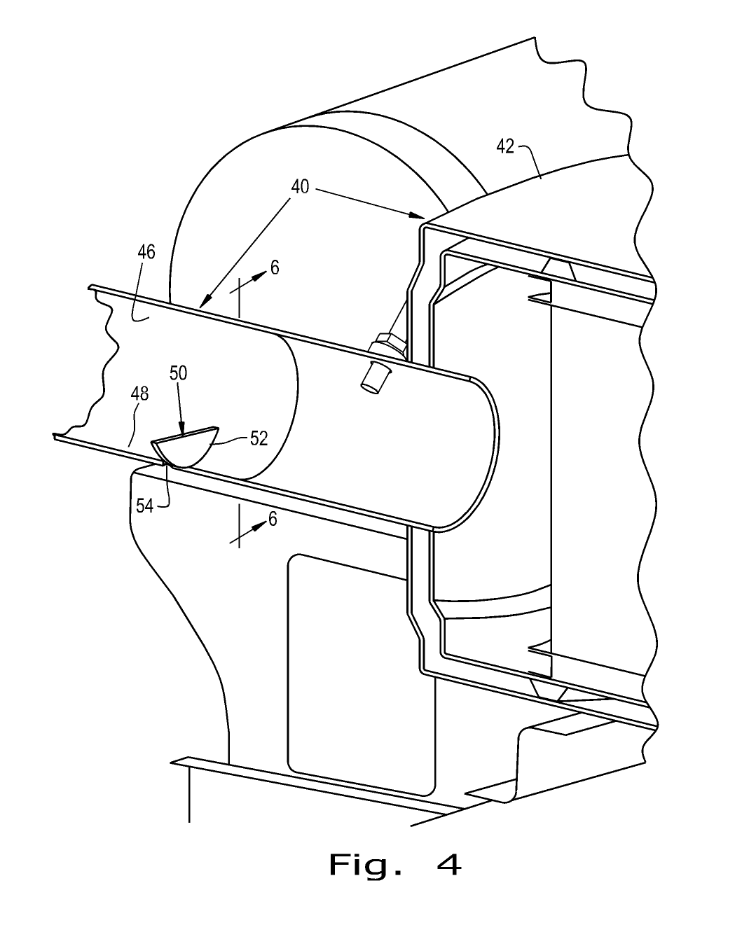

According to an aspect of the present invention, IC engine 13 includes an exhaust system 40 of the present invention. Referring to FIGS. 3 and 4, exhaust system 40 includes a protected component 42 and an exhaust pipe 44 fluidly connected with the protected component 42. The protected component 42 is an exhaust component which is desirably kept dry and free from water which may enter the exhaust system from the ambient environment and flow through the exhaust pipe 44. In the illustrated embodiment, the protected component 42 is in the form of an SCR tank, but it is to be understood that the protected component 42 can be differently configured.

Exhaust pipe 44 includes an inside diameter 46 with a lower surface 48 and a water dam 50 connected with a predefined portion of the lower surface 48, whereby water is inhibited from flowing through the exhaust pipe 44 and into the protected component 42. Exhaust pipe 44 is shown as a tail pipe which is connected with and extends from the protected component 42, but can be a different type of pipe within the exhaust system 40.

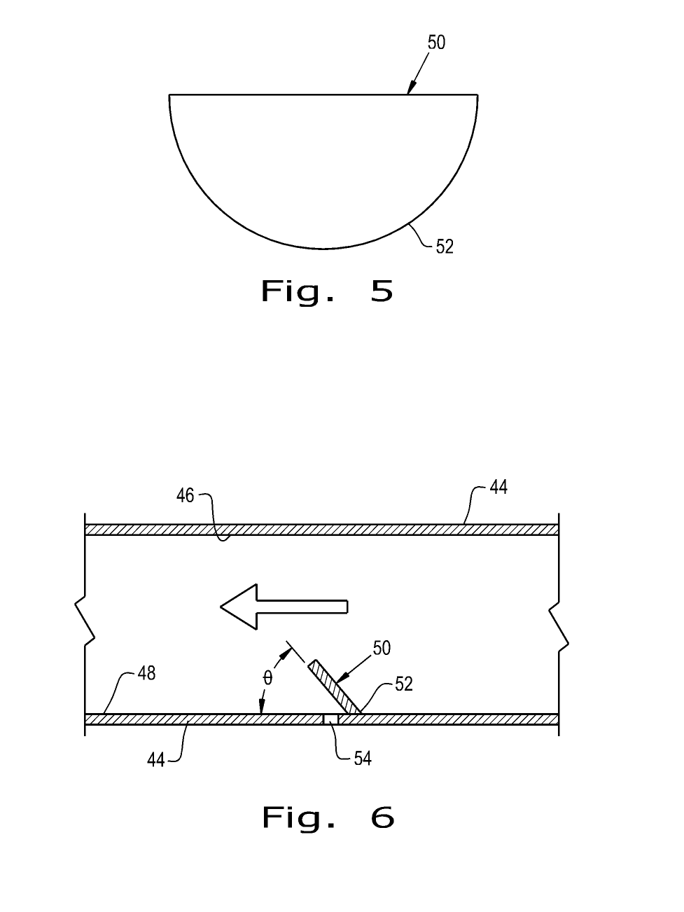

Water dam 50 (FIGS. 4-6) is shown configured as a plate with an outer periphery 52 having a curvature along at least a portion thereof which mates with the inside diameter 46 of the exhaust pipe 44. In the illustrated embodiment, water dam 50 has a portion of outer periphery 52 with a semi-circular shape which mates with the inside diameter 46 of exhaust pipe 44. The exact shape of the water dam 50 can vary, as long as it has a portion thereof which mates with the exhaust pipe 44 in such a way so as to inhibit water from flowing through the exhaust pipe 44 and into the protected component 42. Water dam 50 can be welded or otherwise affixed in a suitable manner to the lower surface 48 at the inside diameter 46 of the exhaust pipe 44.

Referring to FIGS. 4 and 6, water dam 50 can be placed at an acute angle θ relative to a flow of exhaust through the exhaust pipe 44, indicated by the large directional arrow. Positioning the water dam 50 at such an angle allows the exhaust gas to flow over the water dam 50 without back pressure issues, while at the same time forming a “trap” for the water which flows through the exhaust pipe 44. The water is then removed through a hole 54 in exhaust pipe 44 on the downstream side of the water dam 50. Hole 54 is shown positioned under the water dam 50 so that any water trapped under water dam 50 can be drained. However, hole 54 could also be slightly to the downstream side of water dam 50. Hole 54 is sized to prevent water from accumulating on the downstream side of the plate and spilling over the plate.

During use of agricultural sprayer 10, IC engine 13 provides motive power to the wheels 12 and also directly or indirectly powers other driven components onboard sprayer 10. Water which may enter the exhaust pipe 44 flows along the lower surface 48 at the inside diameter 46 of exhaust pipe 44. When the water reaches water dam 50, the angled orientation of water dam 50 traps the water which is then drained through hole 54. Exhaust system 40 therefore inhibits water from entering the protected component defined by SCR tank 42.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle, comprising:
a chassis; and
an internal combustion (IC) engine carried by said chassis, said IC engine including an exhaust system with a protected component and an exhaust pipe fluidly connected with the protected component, the exhaust pipe including an inside diameter with a lower surface and a water dam connected with a predefined portion of the lower surface, whereby water is inhibited from flowing through the exhaust pipe and into the protected component.

2. The vehicle of claim 1, wherein the protected component is a selective catalytic reduction (SCR) tank.

3. The vehicle of claim 1, wherein the water dam is a plate with an outer periphery having a curvature along at least a portion thereof which mates with the inside diameter of the exhaust pipe.

4. The vehicle of claim 3, wherein the plate is placed at an acute angle away from and relative to a flow of exhaust through the exhaust pipe.

5. The vehicle of claim 4, wherein the plate is welded to the lower surface at the inside diameter of the exhaust pipe.

6. The vehicle of claim 4, wherein the plate has a downstream side relative to the flow of exhaust through the exhaust pipe, and wherein the exhaust pipe includes a hole in the lower surface adjacent to the plate on the downstream side of the plate.

7. The vehicle of claim 6, wherein the hole is sized to prevent water from accumulating on the downstream side of the plate and spilling over the plate.

8. The vehicle of claim 1, wherein the exhaust pipe is an exhaust tail pipe.

9. The vehicle of claim 1, wherein the vehicle is a work vehicle.

10. An exhaust system for an internal combustion (IC) engine in a vehicle, comprising:
a protected component; and
an exhaust pipe fluidly connected with the protected component, the exhaust pipe including an inside diameter with a lower surface and a water dam connected with a predefined portion of the lower surface, whereby water is inhibited from flowing through the exhaust pipe and into the protected component.

11. The exhaust system of claim 10, wherein the protected component is a selective catalytic reduction (SCR) tank.

12. The exhaust system of claim 11, wherein the water dam is a plate with an outer periphery having a curvature along at least a portion thereof which mates with the inside diameter of the exhaust pipe.

13. The exhaust system of claim 12, wherein the plate is placed at an acute angle away from and relative to a flow of exhaust through the exhaust pipe.

14. The exhaust system of claim 13, wherein the plate is welded to the lower surface at the inside diameter of the exhaust pipe.

15. The exhaust system of claim 13, wherein the plate has a downstream side relative to the flow of exhaust through the exhaust pipe, and wherein the exhaust pipe includes a hole in the lower surface adjacent to the plate on the downstream side of the plate.

16. The exhaust system of claim 15, wherein the hole is sized to prevent water from accumulating on the downstream side of the plate and spilling over the plate.

17. The exhaust system of claim 10, wherein the exhaust pipe is an exhaust tail pipe.
